(19) United States
(12) Patent Application Publication
(10) Pub. No.: US 2024/0052655 A1
(43) Pub. Date: Feb. 15, 2024

(54) WRAPAROUND STEP COVER FASTENING SYSTEM AND METHOD

(71) Applicant: PREST-O-FIT MANUFACTURING, INC., Chandler, AZ (US)

(72) Inventor: J. David PREST, Tempe, AZ (US)

(73) Assignee: PREST-O-FIT MANUFACTURING, INC., Chandler, AZ (US)

(21) Appl. No.: 18/232,799

(22) Filed: Aug. 10, 2023

Related U.S. Application Data
(60) Provisional application No. 63/396,957, filed on Aug. 10, 2022.

(51) Int. Cl. E04G 21/30; A47G 27/06; A47G 27/04; E04F 11/02; B60R 3/00

(52) U.S. Cl. CPC E04G 21/30; A47G 27/06; A47G 27/0418; E04F 11/02; B60R 3/00; E04F 2011/0203

(57) ABSTRACT

A universal wraparound cover fastening system wherein the cover includes opposed ends mated with a fastening system. The fastening system includes a dual hook spring mechanism, with a first end affixed to an attachment point on the cover, and the opposite end hook mated with an extender. The extender includes at least one eyelet for attaching to the dual hook spring and a hook opposite the eyelet for mating with an attachment point on an opposite end of the cover around a step. The extender may include one or more eyelets along its length. Eyelets may include a single curl, or multiple coils. The wraparound cover can therefore be fitted over numerous side supported step types and sizes with varied extenders to minimize needs to provide additional attachment points on the step covers.

### CLAIM OF PRIORITY

The present application includes subject matter disclosed in and claims priority to a provisional application of the same title, filed Aug. 10, 2022 and assigned Ser. No. 63/396,957, describing an invention made by the present inventor, herein incorporated by reference.

### BACKGROUND OF THE INVENTION

### 1. Field of the Invention

The present invention relates to floating step covers and, more particularly, to a system and method for securing a wraparound step cover.

### 2. Description of Related Prior Art

Numerous types of step covers have been used over the years. The most common step cover is simply material, usually a rubber composition, which is attached to the top of a step by a mastic, brads, or the like. Such a cover may extend partially or fully along the top surface of the step. Some step covers wrap partially around a step such that the opposed edges of the cover extend onto the sides or bottom of the step and are attached by nails, brads, or a mastic. A potentially removable step cover extends partially about each longitudinal edge of a step and partially on to the bottom of the step. The opposing ends of the cover at the bottom of the step are latched with one another by cords or the like penetrably engaging apertures along the edges of the cover under the step.

The first two types of covers discussed above are usually permanently or at least semi-permanently attached to a step. This creates difficulties when the covers are to be replaced due to wear, damage or discoloration. The third type of cover is relatively easily removed but while in operation the forces exerted by the cords tend to cause a cover to pucker due to the non uniform pulling forces exerted by the engaged cords. This puckering renders these types of covers relatively unsightly. If the pucker extends to the top of the step, a safety hazard exists as it may cause a user to trip.

In the recreational vehicle (RV) and camping market, as well as standard industrial and warehouses, there are numerous types, shapes, sizes, etc. of steps for various purposes. Particularly, in the RV industry there are four or five major step types that typically fold up into the side of the RV, or otherwise are collapsible, or placeable when parked. While prior solutions have been proposed for fastening such step covers via a series of grommets and spring hooks, however, due to needs to restrict the number of components in standard step covers, there has yet to be found a way to utilize a universal step cover with a minimum of grommets, or fastening points, that can work with a variety of step heights and depths. These step covers have been traditionally securing with a zip-tie (for modular or varying lengths) or spring (with a standard, known length), however, there remains a need for a spring-type mechanism that may allow for variation in lengths when the size of the step (width or height) varies for a universal-type cover.

### SUMMARY OF THE INVENTION

The present invention is directed to a fastening system for a cover or rug for a step that extends across the top of the step with the longitudinal ends thereof extending along the front and back sides and partially onto the bottom of the step, or to completely cover the step. The fastening system for a wraparound cover for attachment to a step, may include a first dual end hook spring. The spring preferably includes a first end with a first end hook and a second end with a second end hook. The first end of the hook is preferably coupled to a first end of the cover at an attachment point on the wraparound cover. The second end of the hook is preferably coupled with an extender. The extender is preferably an elongated member with an eyelet at one end and a hook at the opposite end. The first, or end, eyelet may be coupled to the second end hook of the spring. The extender hook, opposite the first eyelet may be coupled to a second end of the cover at an opposing or crossed attachment point along an opposite cover end. The extender may include a second eyelet along a length of the extender set apart from the first eyelet via second neck portion, and may include a third eyelet along the length of the extender set apart the second eyelet with a third neck portion. The second and third eyelet and second and third neck may be set within a center space within the spring while the first eyelet is coupled with the spring second end hook. Eyelets useful int eh extender may be single coil, fixed loop, multiple coils, etc.

The present invention also includes a method for covering a step. The step cover may be wrapped across the top of the step and to an underside of the step to locate forward and rear ends of the step cover along the underside of the step. The ends are drawn towards one another leaving a space or gap there in that needs to be overcome with an fastening means that provides a length. The rear edge along a rear end of the step cover may be drawn toward a forward edge along a forward end of the rug. The ends may be coupled via an elongated fastener that may include a dual hook spring fastener that is extended in length by a separate piece extender. The dual hook spring first end may be coupled to a rear end attachment point or a forward end attachment point. The free second end of the dual hook spring may be coupled to an extender. The extender preferably includes an eyelet adapted to couple to the dual hook spring second end (hook). The far end of the extender may be coupled the forward end (or opposite end (rear)) by hooking an extender hook on the extender to the opposite end at an opposite end attachment point. The spring may be affixed to either end, so long as the extender is affixed to its opposite end of the step cover, either directly across or crossed to another attachment point. When stet directly across, the fastened system provides linear tension across the front-back plane of the step cover, whereas when crossed, the fastening system may also provide linear and transverse tension tot eh step cover. The step cover may be fixed to the step with a fastening strip, preferably prior the affixing or coupling of the spring and extender.

The system may be employed to secure a step and step cover for a vehicle with a floating step supporting sides of the step by side walls, the sidewalls coupled to the vehicle, the floating step coupled to a foot supporting the step on a ground surface. Preferably, the step cover is set around the floating step and covers the top and may be secured underneath. A dual-hooked tension spring may be coupled to a first end of the step cover via a first end attachment point. The dual-hooked tension spring may have a far end with a first hook coupled to an eyelet of an extender. The extender preferably includes an elongated body with an eyelet set opposite a hook end, wherein the hook end may be coupled to a second end of the step cover via a second end attachment point.

It is therefore a primary object of the present invention to provide a securing mechanism for a detachably attached cover that extends along the top of a step.

Another object of the present invention is to provide a method to secure a cover that wraps along the top of a step.

A further object of the present invention is to apply a distributed force exerted along opposing ends of the cover to draw them toward one another under the bottom of the step and retain the cover in place.

A yet further object of the present invention is to provide extending or extendable fasteners to a wraparound cover.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates a perspective view of a step system applied to a side of an RV with step covers applied.

FIG. 2 illustrates a side view of a spring and mated extender useful in an embodiment of the present invention.

FIG. 3 illustrates a side view of a spring and alternate mated extender useful in an embodiment of the present invention.

FIG. 4A illustrates a top view of an extender embodiment of the present invention.

FIG. 48 illustrates a side view of the extender shown in FIG. 4A.

FIG. 5A illustrates a side view of a different extender embodiment of the present invention.

FIG. 5B illustrates a top view of the extender shown in FIG. 5A.

FIG. 6A illustrates a side view of an alternate extender embodiment of the present invention.

FIG. 68 illustrates a top view of the extender shown in FIG. 6A.

FIG. 7 illustrates an underside view of a step with a step cover set thereunder.

FIG. 8 illustrates the underside view of a step with a step cover of FIG. 7 with a set of opposing tabs folded over.

FIG. 9 illustrates the underside view of a step with a step cover of FIG. 7 with a set of opposing tabs fastened.

FIG. 10 illustrates the underside view of a step with a step cover of FIG. 7 with a set of opposing tabs fastened and unfastened with a fastening system applied, and partially applied.

FIG. 11 illustrates the underside view of a step with a step cover of FIG. 7 with two sets of opposing tabs fastened.

FIG. 12 illustrates the underside view of a step with a step cover of FIG. 7 with all sets of opposing tabs fastened.

FIG. 13 illustrates a top side view of a step with a step cover set thereupon.

### DETAILED DESCRIPTION OF THE PREFERRED EMBODIMENT

The principal nature of the present invention is to include a universal step cover that can cover a myriad of step sizes and shapes as are known in the art. Particularly, steps are supported on either ends and are free in the front and rear (above and below) for use. In some RV embodiments, steps are supported by side brackets that are hingedly coupled with a bar to the vehicle (not shown). The step cover 10 may be used and applied over a step without interfering with the side mounts or side supports. The step 12 includes a front, back, top, bottom. A fastening patch may be applied to the front of the step for mating with the step cover. The present disclosure incorporates by reference U.S. Pat. No. 9,945,137 entitled “Wraparound Cover for a Step” issued Apr. 17, 2018; U.S. Pat. No. 10,398,245 entitled “Universal wraparound step cover” issued Sep. 3, 2019; and U.S. Pat. No. D956,651 entitled “Wraparound Step Cover” issued Jul. 5, 2022, to the same inventor, the disclosures useful for embodiments of the present invention and hereby incorporated by reference.

The fastening system shown herein is useful as the tie down as shown in U.S. Pat. No. 9,945,137, for example. Similarly, the fastening system may be used with a universal, or other wraparound cover, with or without multiple tabs, and with or without multiple holes/attachment points/grommets per attachment location, or fingered tabs each with their own attachment point(s). The embodiments shown herein and in reference are to be understood as preferred embodiments, but in no way limiting the potential application of the fastening system to specific wraparound covers. Use of the fastener spring with extender of the present invention will lead to the need for less grommet/apertures serving as mounting or attachment points. The flexibility provided by the spring extender allows the same attachment point on a step cover/rug to work with two (or more) sized steps, either with the spring alone, or with the extender provided (or with an election of the appropriate eyelet in the multiple eyelet embodiment. For instance, a rug that required twelve to sixteen grommeted apertures, in four columns, may now utilize one or two less rows, allowing for less grommeted use, down to four to twelve grommets, saving significantly on materials and labor. Additionally, extra material will not be required to cover the gap between free ends under the step, and this gap can be overcome with the extended fastener system and method taught herein.

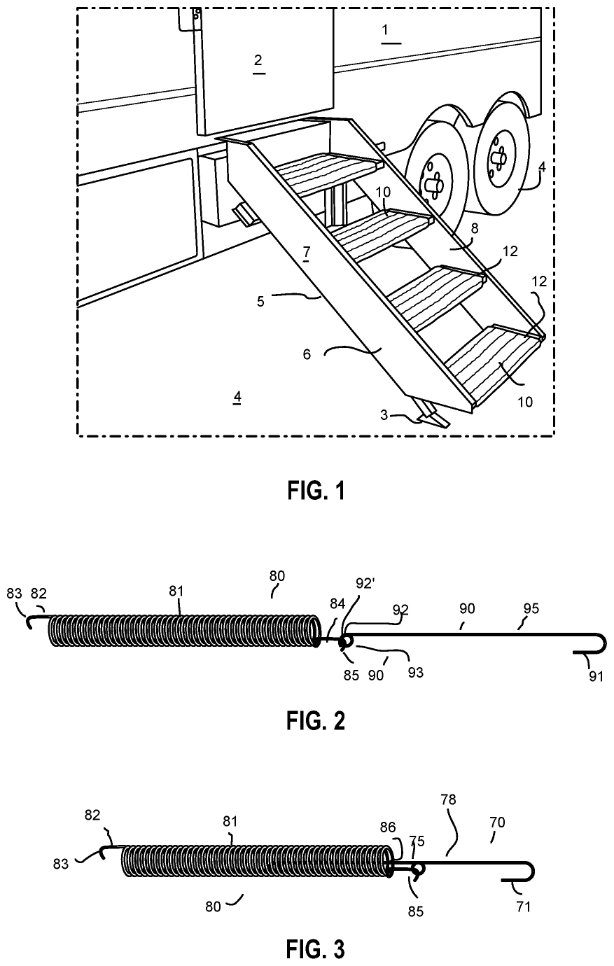

Referring to FIG. 1, a standard recreational vehicle, or RV, 1 may be supported by wheels 4. Step system 5 includes steps 12 that lead to door 2, with foot or feet 3 supporting an end along ground surface 4. Steps 12 preferably include wraparound covers 10 to provide tractions, friction, or otherwise aesthetic enhancement to steps, the steps 12 being floating type steps supporting on sidewalls 7 and 8. As shown, the step system includes sidewalls 6 supporting floating steps 12 of steps 12.

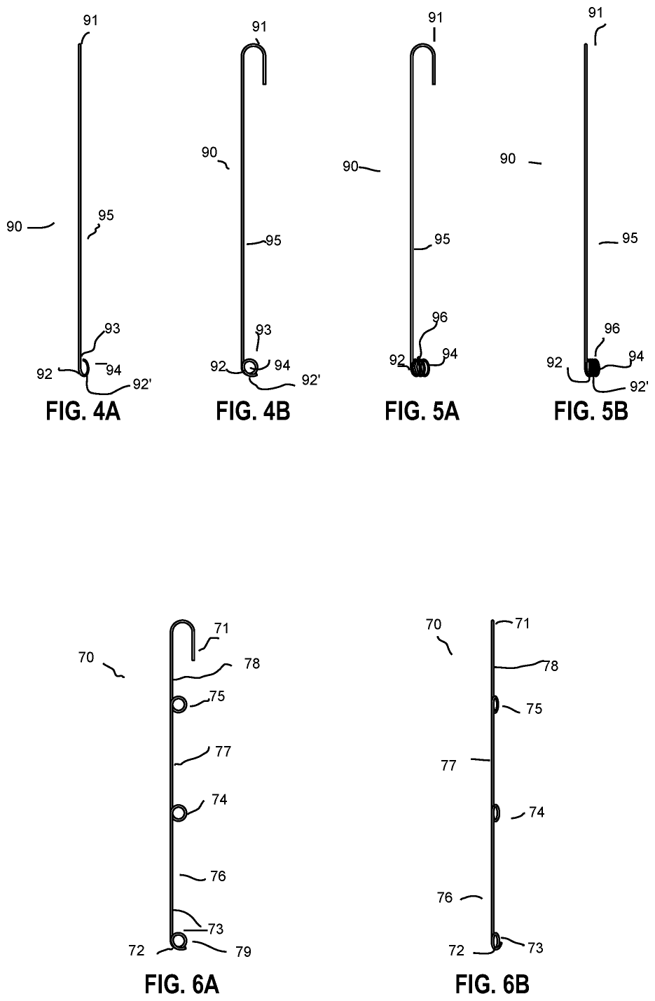

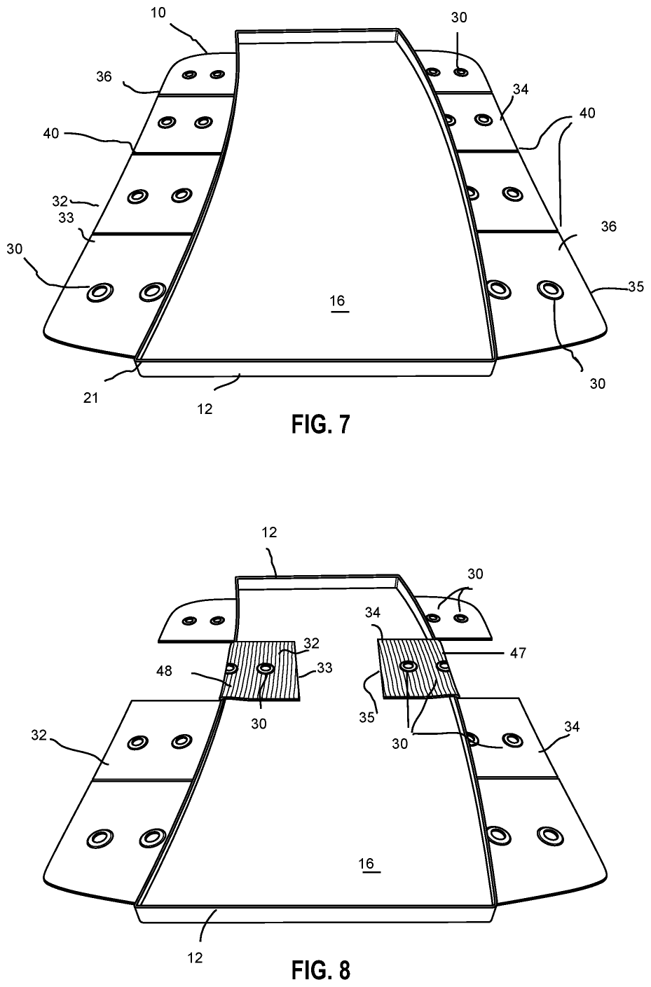

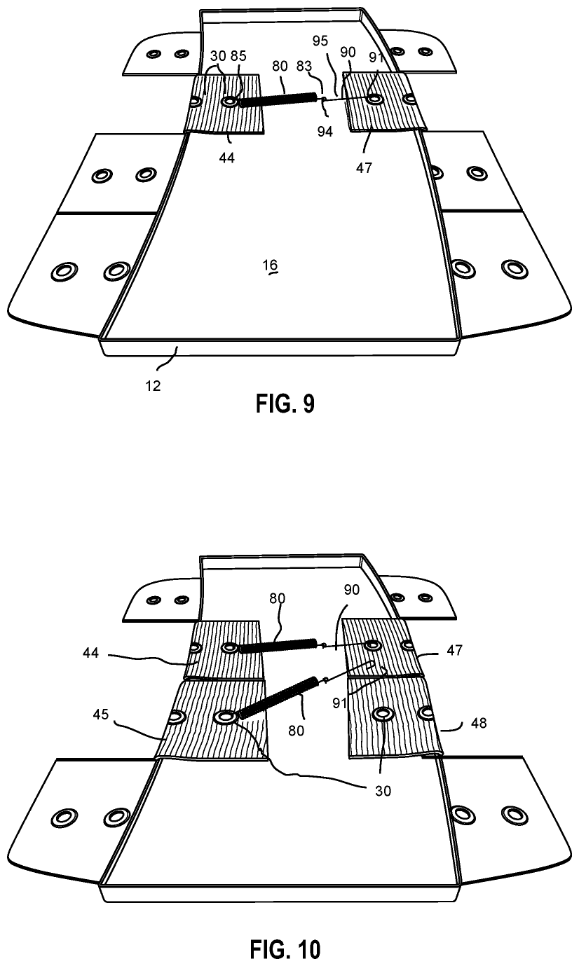

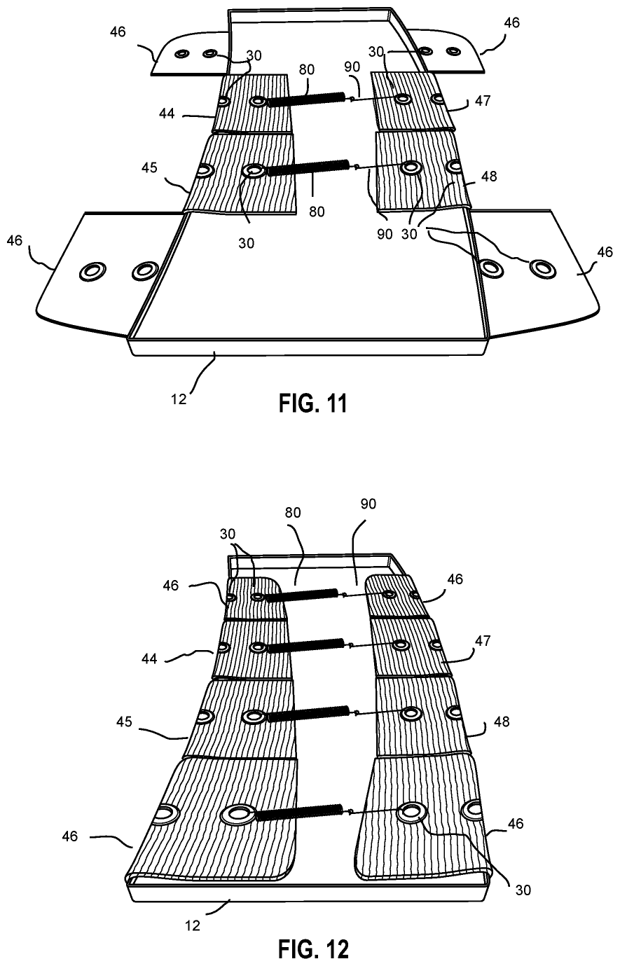

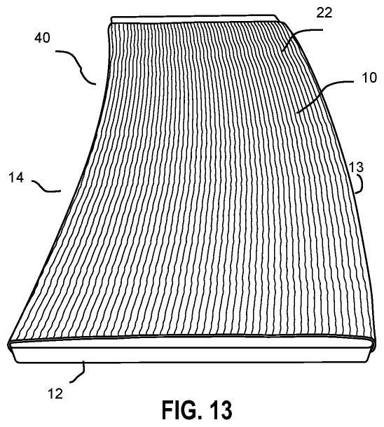

The fastening systems can be understood by looking at representative embodiments, such as a standard dual-hook tension spring 80 with multiple coils 81 to provide primarily tension (when pulled apart), but also torsion forces when twisted. Referring to FIGS. 2-3, dual-hook tension spring 80 may include first end hook 83 extended by first end neck 82 at the first end. Opposite end of neck 82 includes a hook 85 extended by second end neck 84. First end hook 83 is intended to mate either on an attachment point in the prior art, such as an eyelet, or exposed bar, on one end of the wraparound cover/rug, either front or back end of cover. Standard dual-hook tension springs are known in the art, and useful in the art of RV-step covers. A useful spring may include a full length (at rest) of approximately nine centimeters, with a length of wound spring section with coils of five to six centimeters, and the remainder of the length made of the extending neck. The hooks are often bent backwards (as is shown) and do not contribute to the length of the spring. Second end hook 85 may be adapted to mate with an eyelet 94 on an extender 90. Extender or multiple extenders may include single extender 90 or multiple extender 70 and may be used interchangeably.

Preferably extender 90 is sized with a body 95 of specific length adapted for a specific step size (width and height). One preferred single extender includes a length from eyelet to hook end of four to nine centimeters, preferably five to seven centimeters, and more preferably five and-a-half to six and-a-half centimeters. Certain preferred embodiments range from three inches to four and-a-half inches, with a preference for a total length of extender of three and-a-half inches to three and nine sixteenths' inches end to end. A preferred multiple-extender may be eleven to twelve centimeters in total length, with eyelets set from hook end at three to five centimeters, seven to nine centimeters, and ten to twelve centimeters, respectively (for a three eyelet embodiment). Multiple extender may be four and-a-half to five inches in total length. The distance from edge 92′ of butt end 92 of eyelet 94 and opposite to hook 91 is preferably predetermined for a specific step-size (based on manufacturer and model, and may include flat and straight steps eight to twelve centimeters, and curve steps (either curved front, or complete curve (front and back), of eight, nine, ten, eleven centimeters, etc., or and with varying heights of steps from half centimeters to two and-a-half centimeters in height). The coil diameter is preferably between one quarter centimeter and three-quarter centimeters, and most preferably somewhat less than one-half centimeter in diameter, and are preferably round, or circular. The size dimensions of the steps will dictate the distance between cover ends/edges when wrapped there around, necessitating different lengths of fasteners, and potentially the use, or non-use, of extender for a universal over system. The size of spring and extender combine with that known length spring hook to create the fastener length (at rest) with a predetermined extension of spring and fastener length at known tensions. Attachment points may be mated opposite one another, as shown in FIGS. 7-12, to provide linear tension in cover, or may be crossed (angled opposite) to reach attachment points opposite alternative attachments points as is known in the art, to provide for both linear and transverse tension in the step cover, as is known in the art. When the springs fasteners are used for crossed attachment, the spring extenders may be useful to provide an appropriate reach for fasteners systems.

Hook 91 is intended to mate with an opposite, or angled opposite, attachment point on the opposite side of cover. Eyelet 94 is preferably made by curling up, or coiling end 92 to a circle or closed feature 93. The number of coils on closed feature 93 may be determined based on use need, and may number between one and preferably three to live. For instance, if extra tension or torsion is required, closed end may include multiple coils. Additionally, coils may allow extension of the length of the extender.

When multiple sized steps are to be preferred, an alternate, multiple extender 70 may be used. Multiple extender 70 includes hook 71 to mate with attachment point extended by multiple necks. Here, first neck 78 extends between hook 71 and first eyelet 75. First eye 75 mates with spring hook 85, with the remainder of multiple extenders extending in to the center 86 of spring 80. Multiple extender 70 may include hook 71 opposite end 72, with multiple, here shown an embodiment with three, eyelets. First neck 78 extends between hook 71 and first eye 75, second neck extends to second eye 74 from first, and third neck 76 from second to third eye 73. Each of the eyes provide alternate options to attach spring, depending on step size. Coils 79 at end 72 form third eye 73. Coils at any eye may be singular (as shown) or multiple, as shown in FIG. 5, to provide additional tension options through torsion of small coiled spring formed at eyelet. Most preferably, the single coil embodiment includes the coil set around a complete circumference, plus an additional one-quarter to one-half turn. Most preferably, the end of single coiled wire faces ninety degrees form the longitudinal axis of the elongated neck and faces in the same direction as the hook. Ends of wire at third eye 73 may be fixed or welded together, or free (as shown).

Referring to FIGS. 7-13, one may apply and secure a step cover 10 to a step 12. Fasteners 80 are preferably set along under side 16 of step 12. Step 12 is shown flipped over in FIGS. 7-12 for illustrative purposes, but may be oriented as need, with steps up or down, as required by user. Underside 16 of step 12 is preferably exposed with either end rear end 32 and forward end 34 opposite over edges of step, with forward end 34 set opposite read end 32 of cover 10. Rear end 32 and rear edge 33 will be rotated to face opposite portion of step cover, including forward end 34 and forward edge 35. Slits 40 are optional between tabs 36. Each tab may include attachment points, here shown as grommeted holes 30. Attachment points may be exposed openings, apertures, grommeted apertures, or other attachment point in or along a step cover, such as a further attached feature, ringlet, etc. as is known in the art, and may also be useful with the present invention. Again, this invention may be used with singular, multi-tabs ends, so long as an attachment point is available on both sides. While the embodiments shown demonstrate direct attachment to opposite attachment points, fastening systems may be alternatively or diagonally (crossed) applied to ends of the cover.

The present invention is useful for systems with step covers that do not have tabs but is also useful in the tabbed step cover shown. A tab, such as inner tab 48 at rear, may be flipped to face forward tab 47, so that attachment points, such as grommets, are positioned closer to one another. Spring 80 may be affixed to either end (front or rear), here shown to rear end tab 44, with far end hook 85 affixed into attachment point 30 on tab 44. First end hook 83 of spring 80 mate with end eyelet 94 (or any alternate eyelet in multiple extender version), allowing body 95 of extender to extend the distance between spring hook and forward tab. Hook 91 of extender 90 fits into an attachment point on opposite tab (here shown forward tab 47). It is contemplated that the step cover may comprise less grommets, e.g., one grommet or attachment point per tab, that can be used with a modular length provided by one or alternate extenders.

While a wraparound cover with tabs is shown for illustration purposes, the usefulness of the present fasteners system and method are also useful with a solid (not tabbed) cover. Additionally, while the cover shown includes multiple spaced grommeted apertures, the present invention is also useful where a single or single line of apertures or attachment points are provided, such as in an exposed area behind a liner bar, or attachment points along the edge of the cover, etc.

I claim:

1. A fastening system for a wraparound cover for attachment to a step, said fastening system comprising:
(a) a first dual end hook spring, having a first end with a first end hook and a second end with a second end hook, said first end hook coupled to a cover first end attachment point on the wraparound cover, and said second end hook coupled with
(b) an extender, said extender comprising at least a first eyelet coupled to said second end hook, said extender further comprising an extender hook opposite said first eyelet, said extender hook coupled to a cover second end attachment point along an opposite cover end with an attachment point opposite said cover first end attachment point.

2. The fastening system as set forth in claim 1 wherein said extender includes a second eyelet along a length of the extender, said second eyelet set apart said at least first eyelet via second neck portion.

3. The fastening system cover as set forth in claim 2 wherein said extender includes a third eyelet along the length of the extender, said second eyelet set apart said third eyelet via third neck portion.

4. The fastening system cover as set forth in claim 3 wherein the third eyelet is set along a far end of the extender.

5. The fastening system cover as set forth in claim 4 wherein said second and third eyelet and second and third neck are set with a center of the spring, while the at least first eyelet is coupled with said second end hook.

6. The fastening system cover as set forth in claim 1 wherein said at least first eyelet comprises multiple coils.

7. A method for covering a step, said method comprising the steps of:
(a) wrapping a step cover across the top of the step and to an underside of the step to locate forward and rear ends of the step cover along the underside of the step;
(b) drawing a rear edge along a rear end of the step cover toward a forward edge along a forward end of the rug; and
(c) coupling the rear end with the forward end via an elongated fastener by:
(i) coupling a dual hook spring first end to a rear end attachment point, and coupling a dual hook spring second end to an extender, the extender including an eyelet adapted to couple said dual hook spring second end, and coupling a far end of the extender to the forward end by hooking an extender hook on the extender to the forward end at a forward end attachment point.

8. The method of claim 7 further comprising the steps of:
(d) fastening a first fastening strip along a bottom of the step cover with a first complimentary fastening strip along a top side of the step, and
(e) fastening a second first fastening strip along a bottom of the step cover with a second complimentary fastening strip along a front side of the step.

9. The method of claim 7 whereby said step of coupling includes coupling a second end hook to a first eyelet on the extender and placing one or more additional eyelets into a center of the dual hook spring.

10. The method of claim 7 further comprising the step of torsioning the extender eyelet to relieve tension along the fastening system.

11. The method of claim 10 wherein said step of torsioning is provided by unravelling at least a portion of one or more coils on the eyelet.

12. A system for securing a step and step cover for a vehicle with a fastening system, said system comprising:
a. at least one floating step supporting one sides by side walls, the sidewalls coupled to the vehicle, the floating step coupled to a foot supporting the step on a ground surface;
b. a step cover set around the at least one floating step, the step cover covering the top of the at least one floating step, and securing underneath the at least one floating step, wherein the step cover is secured by a fastening system;
c. said fastening system comprising at least a first dual-hooked tension spring coupled to a first end of the step cover via a first end attachment point, said first dual-hooked tension spring having a far end comprising a first hook coupled to an eyelet of an extender, said extender comprising an elongated body with an eyelet set opposite a hook end, said eyelet hook end coupled to a second end of the step cover via a second end attachment point.

13. The system as set forth in claim 12 wherein the eyelet comprises a single revolution.

14. The system as set forth in claim 12 wherein the eyelet comprises a more than one revolution.
